(19) United States
(12) Patent Application Publication
(10) Pub. No.: US 2017/0034791 A1
(43) Pub. Date: Feb. 2, 2017

(54) CONTROL DEVICE, SENSOR TERMINAL, AND CONTROL SYSTEM

(71) Applicant: KABUSHIKI KAISHA TOSHIBA, Tokyo (JP)

(72) Inventors: Yuji TOHZAKA, Kawasaki (JP); Fumiaki KANAYAMA, Kawasaki (JP); Yusuke DOI, Kawasaki (JP)

(21) Appl. No.: 15/220,561

(22) Filed: Jul. 27, 2016

(30) Foreign Application Priority Data
Jul. 28, 2015 (JP) 2015-148517

(51) Int. Cl. H04W 52/34; H04M 1/725; H04W 52/46; H04W 4/00

(52) U.S. Cl. CPC H04W 52/346; H04W 4/005; H04M 1/72527; H04W 52/46

(57) ABSTRACT

According to an embodiment, a control device is connected to a network including sensor terminals having wireless communication function. The control device includes a collecting unit, a calculating unit, a deciding unit, and a communication control unit. The collecting unit collects, from the sensor terminals, electrical power data containing, from among amount of stored electricity and electric-generating capacity of the sensor terminal, at least the amount of stored electricity and containing relationship information of a communicable sensor terminal. The calculating unit generates, based on the relationship information, relay path candidates for communication data and calculates, for the relay path candidates, power consumption of the sensor terminal. The deciding unit decides on a relay path for communication among the sensor terminals based on the calculated power consumption and the collected electrical power data. The communication control unit notifies the sensor terminal about information of the decided relay path.

### CROSS-REFERENCE TO RELATED APPLICATIONS

This application is based upon and claims the benefit of priority from Japanese Patent Application No. 2015-148517, filed on Jul. 28, 2015; the entire contents of which are incorporated herein by reference.

### FIELD

An embodiment described herein relates generally to a control device, a sensor terminal, and a control system.

### BACKGROUND

Typically, a sensor network is known in which various sensors capable of performing wireless communication are installed, and a variety of data measured by the sensors is collected. In the sensor network, the sensors relay data with each other in such a way that a variety of measured data is transferred to a sink node that is meant for collecting data. Each sensor includes a battery and operates on the electricity stored in the battery. Examples of a battery include a battery in which an energy harvesting device is installed for converting environmental energy (for example, natural sunlight or vibrations) into electrical energy and storing the generated electricity.

In such a sensor network, since transmission power is required at the time of performing a data relay operation, it becomes important to hold down the consumption of electricity stored in the batteries. In that regard, in the sensor network, in the case of using batteries not equipped with an energy harvesting device, there is a technology available for setting an upper limit to the number of connections and deciding on the relay path or there is a technology available for deciding on the relay path based on the surplus electricity in the batteries. In the case of using batteries equipped with an energy harvesting device, there is a technology available for adjusting the measurement cycle based on the state of the energy harvesting devices, such as based on the electrical power balance in each sensor, and changing the relay path if adjustment of the measurement cycle cannot be achieved.

### BRIEF DESCRIPTION OF THE DRAWINGS

FIG. 1 is a diagram a system configuration of a control system;

FIG. 2 is a diagram illustrating a hardware configuration of a control device;

FIG. 3 is a diagram illustrating a hardware configuration of a sensor terminal;

FIG. 4 is a block diagram illustrating a functional configuration of the control device;

FIG. 5 is a block diagram illustrating a functional configuration of the sensor terminal;

FIG. 6 is a flowchart for explaining a flow of operations performed during a control operation;

FIG. 7 is a diagram illustrating the communication range for each transmission power setting of each sensor terminal;

FIG. 8 is a diagram for explaining examination of the transmission power settings and the relationship of connection among the sensor terminals;

FIG. 9 is a diagram illustrating the transmission power settings and the relationship of connection managed by the control device;

FIG. 10 is a diagram illustrating communication performed using relay paths;

FIG. 11 is a diagram illustrating a frame format;

FIG. 12 is a diagram illustrating the relay path of a super frame and the allocation of time slots;

FIG. 13 is a diagram illustrating the consumption current during the transmission from a particular sensor terminal;

FIG. 14A is a diagram illustrating the temporal transition in the residual battery level of the sensor terminals according to the conventional technology;

FIG. 14B is a diagram illustrating the temporal transition in the residual battery level of the sensor terminals according to an embodiment; and

FIG. 15 is a block diagram illustrating another functional configuration of the control device according to an embodiment.

### DETAILED DESCRIPTION

According to an embodiment, a control device is connected to a network including sensor terminals having wireless communication function. The control device includes a collecting unit, a calculating unit, a deciding unit, and a communication control unit. The collecting unit collects, from the sensor terminals, electrical power data containing, from among amount of stored electricity and electric-generating capacity of the sensor terminal, at least the amount of stored electricity and containing relationship information of a communicable sensor terminal. The calculating unit generates, based on the relationship information, a plurality of relay path candidates for communication data and calculates, for the relay path candidates, power consumption of the sensor terminal. The deciding unit decides on a relay path for communication among the sensor terminals based on the calculated power consumption and the collected electrical power data. The communication control unit notifies the sensor terminal about information of the decided relay path.

### Embodiment

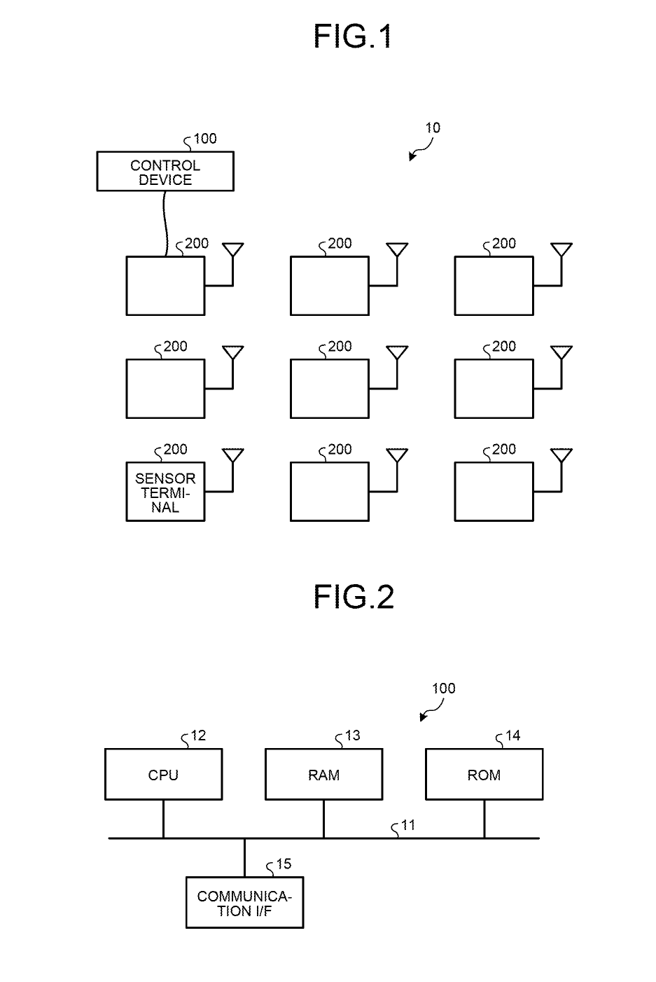

FIG. 1 is a diagram illustrating an exemplary system configuration of a control system 10 according to an embodiment. As illustrated in FIG. 1, the control system 10 includes a control device 100 and a plurality of sensor terminals 200. In FIG. 1, the control device 100 is illustrated to be connected to one sensor terminal 200 in a wired manner. However, the control device 100 can alternatively be embedded in the sensor terminal 200. Still alternatively, the control device 100 can include a wireless communication function so as to be provided separately from the sensor terminal 200. Meanwhile, in the embodiment, for the purpose of illustration, for example, regarding the characteristic features of radio wave propagation and power consumption, the assumption is simplified within the range of not losing the generality.

The control device 100 collects a variety of data from the sensor terminals 200. Moreover, the control device 100 issues instructions for controlling the sensor terminals 200. The sensor terminals 200 represent sensor network terminals capable of performing wireless communication, and run on a battery. In each sensor terminal 200 according to the embodiment, electricity supplied from a power source can be stored in the battery or electricity generated by an energy harvesting device can be stored in the battery.

Each sensor terminal 200 sends measurement data measured using the corresponding sensor and electrical power data regarding the corresponding battery to other sensor terminals 200 by following the relay path instructed by the control device 100. Moreover, each sensor terminal 200 sends, to other sensor terminals 200 by following the relay path instructed by the control device 100, measurement data and electrical power data received from other sensor terminals 200. As a result, a variety of data, such as measurement data and electrical power data, that is sent and received among the sensor terminals 200 is collected by the control device 100.

FIG. 2 is a diagram illustrating an exemplary hardware configuration of the control device 100 according to the embodiment. As illustrated in FIG. 2, the control device 100 includes a central processing unit (CPU) 12, a random access memory (RAM) 13, a read only memory (ROM) 14, and a communication interface (I/F) 15. Moreover, the hardware components are connected to each other by a system bus 11.

The CPU 12 controls the operations of the entire control device 100. The CPU 12 uses the RAM 13 as the work area, and executes computer programs stored in the ROM 14 so as to control the operations of the entire control device 100. The RAM 13 represents the work area during the execution of computer programs stored in the ROM 14. The ROM 14 stores therein computer programs for implementing the operations of the control device 100. The communication I/F 15 is an interface for controlling the communication performed in a wired and wireless manner.

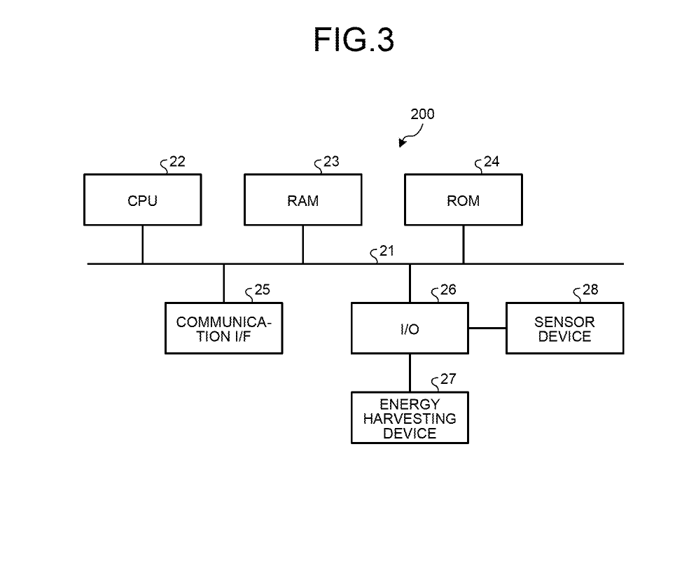

FIG. 3 is a diagram illustrating an exemplary hardware configuration of the sensor terminal 200 according to the embodiment. As illustrated in FIG. 3, the sensor terminal 200 includes a CPU 22, a RAM 23, a ROM 24, a communication I/F 25, an input/output (I/O) 26, an energy harvesting device 27, and a sensor device 28. Moreover, the hardware components are connected to each other by a system bus 21.

The CPU 22 controls the operations of the entire sensor terminal 200. The CPU 22 uses the RAM 23 as the work area, and executes computer programs stored in the ROM 24 so as to control the operations, such as measurement done by the sensors, generation and storage of electricity in the battery, and transmission and reception of measurement data and electrical power data, of the entire sensor terminal 200. The RAM 23 temporarily stores therein the measurement data and the electrical power data, and represents the work area during the execution of computer programs stored in the ROM 24. The ROM 24 stores therein the computer programs for implementing the operations of the sensor terminal 200. The communication I/F 25 is an interface for controlling the communication performed in a wired or wireless manner. The I/O 26 controls the input and output of a variety of information, such as the measurement data and the electrical power data, as well as control signals with respect to the energy harvesting device 27 and the sensor device 28. Under the control of the CPU 22, the energy harvesting device 27 generates and stores electricity in the battery, regulates the electrical power used in the sensor terminal 200, and inputs electrical power data. The sensor device 28 represents various sensors that detect light, heat, and sound, and input measurement data.

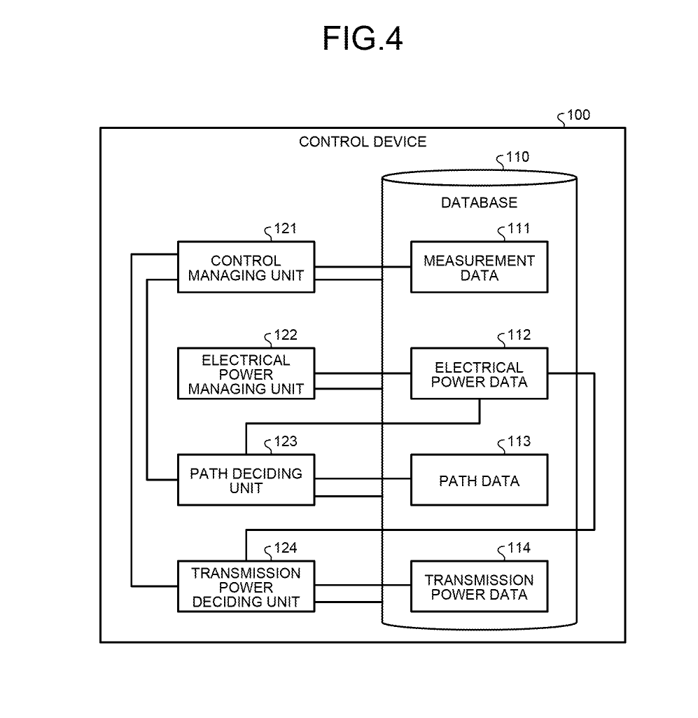

FIG. 4 is a block diagram illustrating an exemplary functional configuration of the control device 100 according to the embodiment. As illustrated in FIG. 4, the control device 100 includes a database 110 containing measurement data 111, electrical power data 112, path data 113, and transmission power data 114. Moreover, the control device 100 includes a control managing unit 121, an electrical power managing unit 122, a path deciding unit 123, and a transmission power deciding unit 124. Some or all of the control managing unit 121, the electrical power managing unit 122, the path deciding unit 123, and the transmission power deciding unit 124 can be implemented either using software (computer programs) or using hardware.

The control managing unit 121 performs control with respect to the sensor terminals 200 as well as manages the measurement data collected from the sensor terminals 200.

For example, the control managing unit 121 collects the measurement data from the sensor terminals 200 included in the control system 10, and stores the measurement data in the database (the measurement data 111). Moreover, the control managing unit 121 issues instructions for performing control with respect to the sensor terminals 200 included in the control system 10. Herein, the control managing unit 121 corresponds to a “notification control unit” that performs control to notify the sensor terminals 200 about the information on the decided relay path.

The electrical power managing unit 122 manages the electrical power data collected from the sensor terminals 200. For example, the electrical power managing unit 122 collects the electrical power data from the sensor terminals 200 included in the control system 10, and stores the electrical power data in the database (the electrical power data 112). The electrical power data stored in the electrical power data 112 is managed, for each sensor terminal 200, over a predetermined period of time in the past and in association with acquisition date data. Moreover, the electrical power managing unit 122 further collects relationship information of the communicable sensor terminals 200. For example, the electrical power managing unit 122 collects, from the sensor terminals 200 included in the control system 10, the relationship of connection of other communicable sensor terminals 200 with each corresponding sensor terminal 200; and stores the obtained information as path data in the path data 113. Herein, the electrical power managing unit 122 corresponds to a “collecting unit” that collects, from each sensor terminal 200, electrical power data containing at least the amount of stored electricity from among the amount of stored electricity and the electric-generating capacity of the concerned sensor terminal 200, along with collecting the relationship of connection with the communicable sensor terminals 200. That is, when the sensor terminal 200 does not generate electricity using an energy harvesting device, the electrical power managing unit 122 collects the amount of stored electricity as the electrical power data. On the other hand, when the sensor terminal 200 generates electricity using an energy harvesting device, the electrical power managing unit 122 collects the amount of stored electricity and the electric-generating capacity as the electrical power data.

The path deciding unit 123 decides on the relay path based on the path data and the electrical power data. For example, the path deciding unit 123 determines whether or not the relay path needs to be changed based on the path data stored in the database (the path data 113) and the electrical power data of the sensor terminals 200 included in the path (i.e., the electrical power data obtained from the electrical power data 112); and, if the relay path needs to be changed, selects and decides on the relay path. Herein, the path deciding unit 123 corresponds to a “calculating unit” that generates, based on the relationship information, a plurality of relay path candidates for relaying communication data and calculates, for each relay path candidate, the power consumption of the sensor terminals 200. The path deciding unit 123 also corresponds to a “deciding unit” that decides on the relay path for communication among the sensor terminals 200 included in the control system 10 based on the calculated power consumption and the collected electrical power data. For the sensor terminal 200 having a greater number of other sensor terminals 200 via which the communication data is relayed, the power consumption is calculated to be a greater value. Meanwhile, the communication data points to all data which is sent and received as a result of communication among the sensor terminals 200.

The transmission power deciding unit 124 decides on the transmission power based on the electrical power data of the sensor terminals 200. For example, based on the electrical power data of each sensor terminal 200 stored in the database (the electrical power data 112), the transmission power deciding unit 124 determines whether or not the transmission power needs to be changed and, when the transmission power needs to be changed, decides on the transmission power. Herein, the transmission power deciding unit 124 corresponds to a “deciding unit” that decides on the transmission power of the sensor terminals 200 based on setting information of transmission power and the electrical power data.

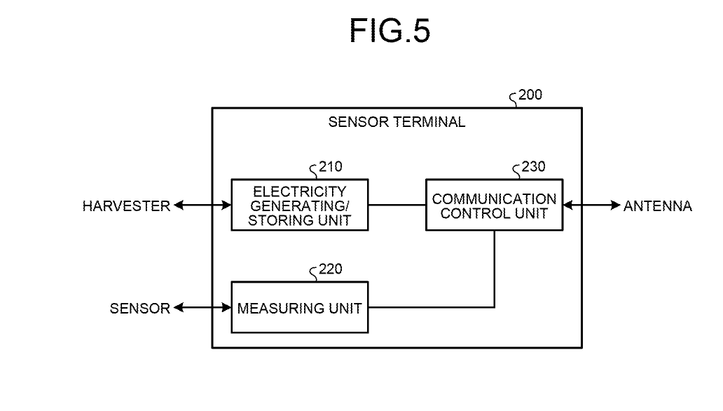

FIG. 5 is a block diagram illustrating an exemplary functional configuration of the sensor terminal 200 according to the embodiment. As illustrated in FIG. 5, the sensor terminal 200 includes an electricity generating/storing unit 210, a measuring unit 220, and a communication control unit 230.

The electricity generating/storing unit 210 performs control so that the electrical power generated by a harvester is supplied to the load and stored in the battery. Herein, the electricity generating/storing unit 210 corresponds to a “detecting unit” that detects the amount of stored electricity in the battery or the electric-generating capacity. Meanwhile, the electricity generating/storing unit 210 can be separated into an “electricity storing unit” such as a battery for storing electricity and an “electricity generating unit” for generating electricity. The measuring unit 220 supplies the electrical power required by the sensors for measurement, obtains measurement values from the sensors, and stores the measurement values as digital values.

The communication control unit 230 performs control for sending a variety of data to and receiving a variety of data from the control device 100 either directly or using the relay via other sensor terminals 200. The data that is sent and received contains the measurement values obtained by various sensors, electrical power information such as the amount of stored electricity and the electric-generating capacity detected by the electricity generating/storing unit 210, setting information of the transmission power, and the relationship of connection (described later). Thus, the sensor terminal 200 is equipped with the function that enables wireless communication under the control of the communication control unit 230. Moreover, the sensor terminal 200 is equipped with the function of relaying a variety of data and the function of setting the transmission power into a plurality of steps using a power amplifier. That is, the transmission power can be variable in nature. Meanwhile, in the wired communication performed with the control device 100, it is desirable to achieve the transmission speed equal to or greater than the maximum transmission speed achievable in the wireless communication. Herein, the communication control unit 230 corresponds to a “relaying unit” that relays the electrical power data and the setting information of the transmission power to the control device 100. Moreover, the communication control unit 230 corresponds to a “setting changing unit” that changes the setting of the relay path and the transmission power according to a notification from the control device 100.

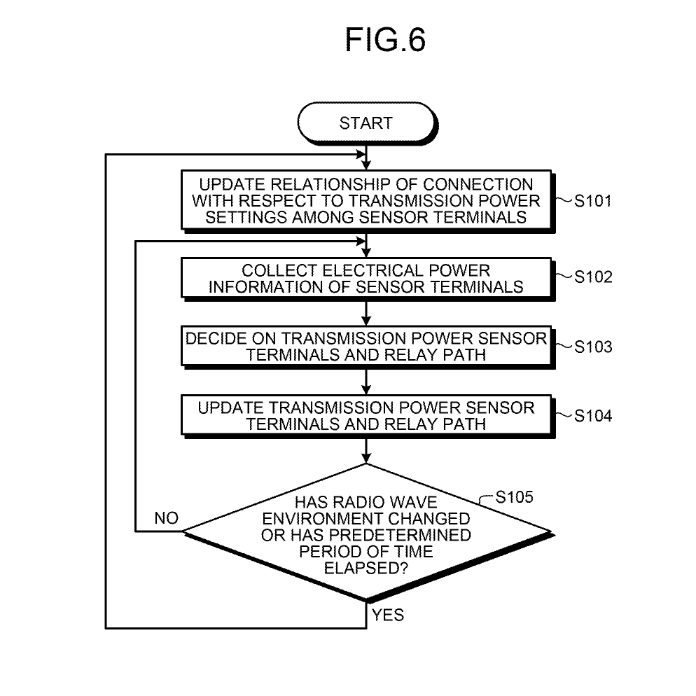

FIG. 6 is a flowchart for explaining an exemplary flow of operations performed during a control operation according to the embodiment. After the start of operations in the control system 10, until the control device 100 decides on the relay path, the relay path according to a known method is used. For example, regarding the temporary relay path to be used until the control device 100 decides on the relay path, the relay path having the least number of hops according to the flooding started by the sensor terminal 200 connected to the control device 100 is used.

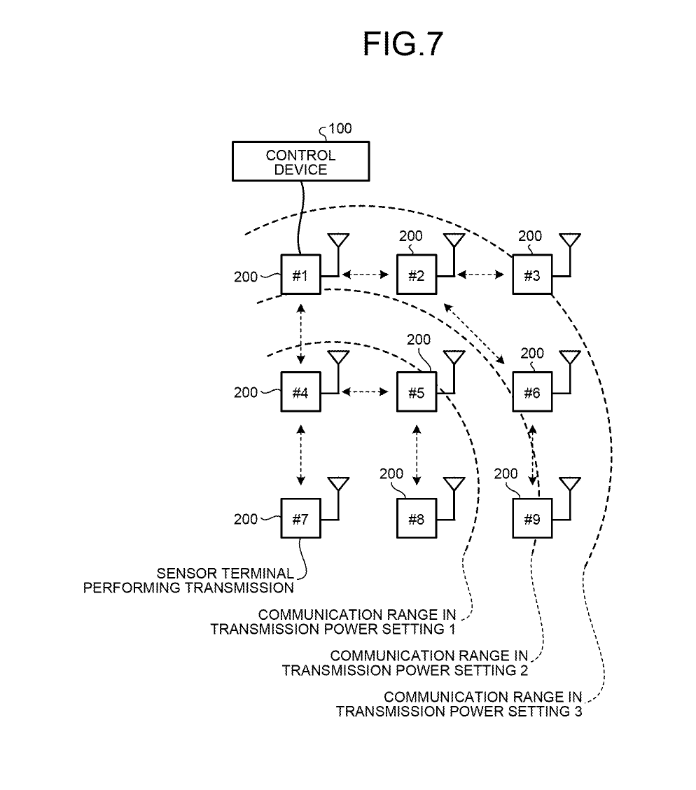

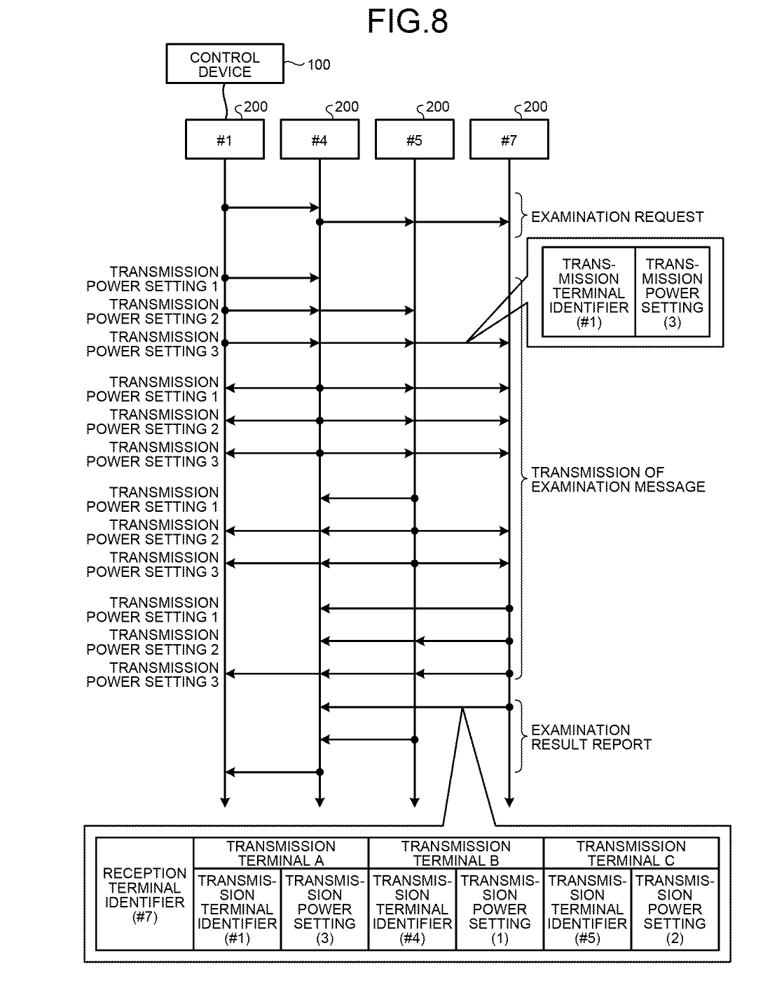

As illustrated in FIG. 6, the control device 100 updates the relationship of connection with respect to the transmission power settings among the sensor terminals 200 (Step S101). The explanation of this operation is given with reference to FIGS. 7 and 8. FIG. 7 is a diagram illustrating an example of the communication range for each transmission power setting of each sensor terminal 200 according to the embodiment. With reference to FIG. 7, sensor terminals #1 to #9 represent the sensor terminals 200, and the explanation is given for an example of the communication range for each transmission power setting of the sensor terminal #7 that represents one of the sensor terminals 200. That is, the sensor terminal #7 represents the sensor terminal 200 that is performing transmission.

As illustrated in FIG. 7, with the antenna position serving as the reference, the communication range of transmission power setting 1 includes the sensor terminals #4 and #8. Similarly, the communication range of transmission power setting 2 includes the sensor terminal #5. Moreover, the communication range of transmission power setting 3 includes the sensor terminals #1, #2, #6, and #9. In the example illustrated in FIG. 7, regardless of which transmission power setting (which of the transmission power settings 1, 2, and 3) is used, the sensor terminal #7 cannot perform direct communication with the sensor terminal #3. Thus, each sensor terminal 200 can establish connection for wireless communication with other sensor terminals 200 present in the communication range of the corresponding transmission power setting.

FIG. 8 is a diagram for explaining an example of examining the transmission power settings and the relationship of connection among the sensor terminals 200 according to the embodiment. With reference to FIG. 8, it is assumed that the relay path illustrated in FIG. 7 is established, and the explanation is given for only some of the sensor terminals 200 (the sensor terminals #1, #4, #5, and #7) for the purpose of illustration. However, in practice, all sensor terminals 200 operate in an identical manner.

As illustrated in FIG. 8, the sensor terminal #1 that is connected to the control device 100 sends a message as an examination request instruction. The message sent by the sensor terminal #1 is received by all sensor terminals 200 via the relay path. In the example illustrated in FIG. 8, the message sent as an examination request instruction is received by the sensor terminals #4, #5, and #7.

Then, each sensor terminal 200 sends an examination message in the time slot allocated thereto in advance. As an example, the sensor terminal #1 sends an examination message to the sensor terminal #4 with the transmission power setting 1, sends an examination message to the sensor terminal #5 with the transmission power setting 2, and sends an examination message to the sensor terminal #7 with the transmission power setting 3. An examination message at least includes a “transmission terminal identifier” representing the identifier of the source sensor terminal 200, and “transmission power setting” representing the transmission power setting of the source sensor terminal 200. As an example, the sensor terminal #1 sends a transmission terminal identifier “#1 (the identifier of the sensor terminal #1)” and transmission power setting “3 (the transmission power setting 3)” to the sensor terminal #7. Meanwhile, an examination message can also include header information that is typically used in communication.

As the allocation of the time slots, as described in an example given later, the allocation for the purpose of data communication can be used as it is. Alternatively, it is possible to separately allocate time slots for examination messages. Moreover, as the allocation of the time slots for sending examination messages, as long as the allocated time slots do not overlap among the sensor terminals 200, the allocation can be done according to any arbitrary method. In this way, each sensor terminal 200 varies the transmission power setting within the allocated time slot, and sends an examination message. In the example illustrated in FIG. 8, transmission of examination messages is done in ascending order of the transmission power settings. However, the order of transmission of the examination messages can be set in an arbitrary manner.

When examination messages are received; the sensor terminal 200 stores, from among the successfully-received examination messages, the information of the transmission power setting having the smallest transmission power along with the corresponding transmission terminal identifier. Thus, if examination messages sent with the settings of the transmission power setting 1, the transmission power setting 2, and the transmission power setting 3 are received; the sensor terminal 200 stores, in an association manner, the transmission power setting and the transmission terminal identifier received during the transmission power setting 1, which is the transmission power setting having the smallest transmission power. Meanwhile, whether or not an examination message is successfully received can be determined based on a demodulation result and further based on the communication quality such as the reception power or the signal-to-noise ratio (SINR).

Subsequently, when the planned transmission of the examination message is completed, the sensor terminal 200 sends the examination result in the form of an examination result report to the control device 100. The examination result report includes a “reception terminal identifier” representing the identifier of the sensor terminal 200 that received the examination message (i.e., the sensor terminal 200 that is the source of the examination result report), “identifier” representing the identifier of each of the other sensor terminals 200, and “transmission power setting” representing the transmission power setting in each of the other sensor terminals 200. As an example, the examination result report sent by the sensor terminal #7 to the control device 100 includes the reception terminal identifier “#7”, the identifier “#1” related to a transmission terminal A representing one of the other sensor terminals 200, the transmission power setting “3”, the identifier “#4” related to a transmission terminal B representing one of the other sensor terminals 200, the transmission power setting “1”, the identifier “#5” related to a transmission terminal C representing one of the other sensor terminals 200, and the transmission power setting “2”. Meanwhile, the relay transmission illustrated in FIG. 8 represents an example in which the time slots are allocated in descending order of the number of hops in the relay path illustrated in FIG. 7.

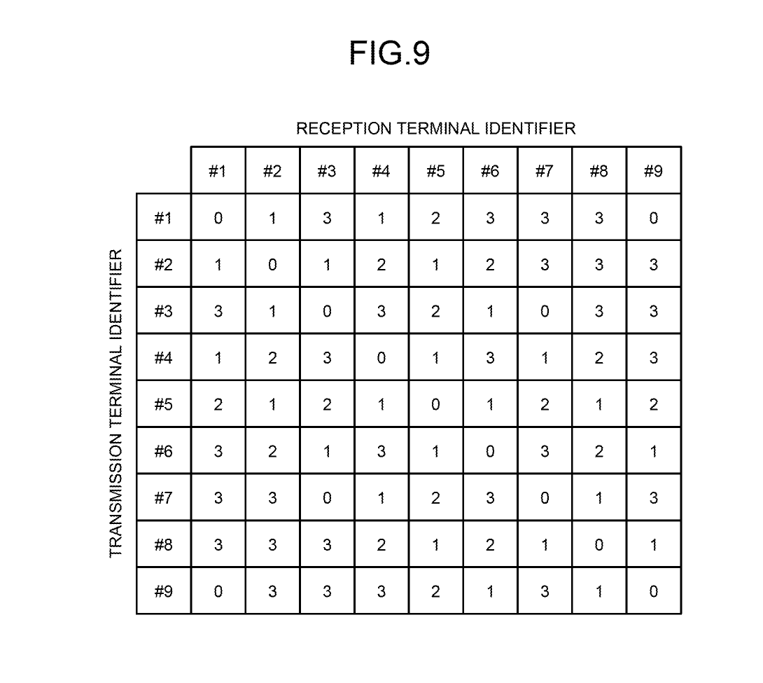

As a result, the control device 100 can collect the information about the transmission power settings and the relationship of connection among the sensor terminals 200 included in the control system 10. FIG. 9 is a diagram illustrating an example of the transmission power settings and the relationship of connection managed by the control device 100. As illustrated in FIG. 9, the control device 100 collects the examination result reports and manages the transmission power settings in the form of a table in which the vertical axis represents the transmission terminal identifiers and the horizontal axis represents the reception terminal identifiers.

Meanwhile, in response to an examination request from the control device 100, the sensor terminal 200 may send an examination message and an examination result report only if predetermined conditions are satisfied. Whether or not predetermined conditions are satisfied can be determined based on, for example, the amount of stored electricity in the battery, a metric calculated from the amount of stored electricity as well as the electric-generating capacity, and a comparison result with a predetermined threshold value. If the predetermined conditions are not satisfied, then the examination message and the examination result report are not sent. As a result, in the control system 10, it becomes possible to achieve electrical power saving. In that case, although the control device 100 cannot collect any new examination result report from the corresponding sensor terminal 200, it does not matter because a relay path deciding operation (described later) is performed based on the information obtained in the past. Meanwhile, even though the sensor terminal 200 does not satisfy predetermined conditions, it is made to perform relay transmission as may be necessary.

Returning to the explanation with reference to FIG. 6, the control device 100 collects electrical power information of the sensor terminals 200 (Step S102). More particularly, the control device 100 collects the electrical power data (the amount of stored electricity, or both of the amount of stored electricity and the electric-generating capacity) of the sensor terminals 200. At that time, each sensor terminal 200 sends the measurement data measured by the sensors as well as sends the electrical power data to the control device 100. The measurement data and the electrical power data is either directly received by the control device 100 or is relayed via the sensor terminals 200 to the control device 100. Then, the control device 100 decides on the relay path and allocates time slots for communication to the sensor terminals 200.

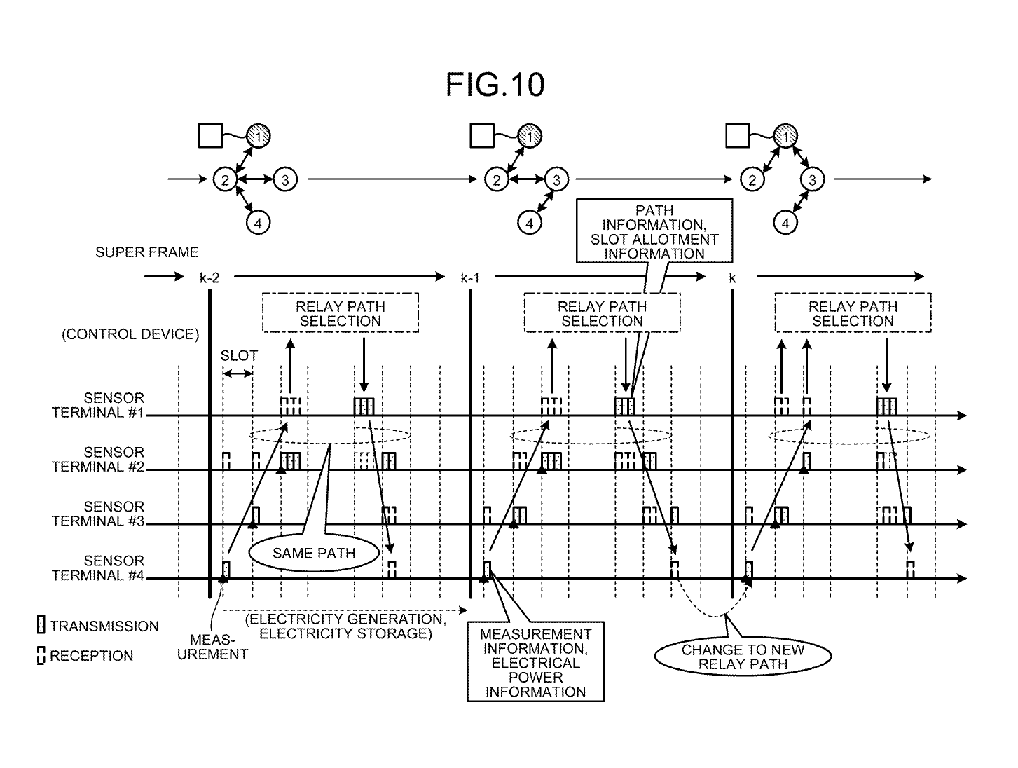

FIG. 10 is a diagram illustrating an example of communication performed using relay paths according to the embodiment. In the communication performed using relay paths, a period of time called a super frame is repeated, and it is desirable to have the setting in such a way that the super frames represent a multiple of the measurement cycle. The super frame is divided into an uplink period (transmission from the sensor terminals 200 to the control device 100) and a downlink period (transmission from the control device 100 to the sensor terminal 200). Of those periods, in the uplink period, greater the number of hops from the sensor terminal 200 to the control device 100, the earlier is the time slot allocated to that sensor terminal 200. On the other hand, in the subsequent downlink period, smaller the number of hops from the sensor terminal 200 to the control device 100, the earlier is the time slot allocated to that sensor terminal 200. As a result of allocating the time slots in this manner, temporal coordination at the super frame level can be achieved between the control device 100 and each sensor terminal 200; and it becomes possible to perform communication in which the transmission delay falls within the period of time of the super frames.

The communication method implemented by the sensor terminals 200 and the method of allocation of time slots are not limited to the methods described above. That is, it is alternatively possible to implement any arbitrary methods. Moreover, communication can also be performed using frequency hopping in which the frequency channel is changed for each time slot. That is called time synchronized mesh protocol (TSMP) or time slotted channel hopping (TSCH); and it is necessary to allocate frequency channels in addition to allocating time slots, and notify the sensor terminals 200 about the same. Meanwhile, the uplink and the downlink need not be identical. In the following explanation, for the purpose of illustration, it is assumed that the relay path is identical in the uplink and in the downlink. In the example illustrated in FIG. 10, the relay path of a super frame k is decided based on the information on the electric-generating capacity in a super frame k−2 and the information on the amount of stored electricity at the start of a super frame k−1.

In the allocation of the time slots for data communication, the allocated time slots can be allowed to overlap among the sensor terminals 200. In this case, the control device 100 needs to know, from the relationship of connection illustrated in FIG. 9 and the transmission power settings of the sensor terminals 200, the relations of radio wave interference among the sensor terminals 200, so as to allocate the same time slot to the sensor terminals 200 having no communication interference with each other. For example, when the relay path illustrated in FIG. 7 is established, from the transmission power settings and the relationship of connection illustrated in FIG. 9, the sensor terminal 200 to receive the uplink communication of the sensor terminal #7 is the sensor terminal #4, and the sensor terminal 200 to receive the uplink communication of the sensor terminal #9 is the sensor terminal #6. When it is assumed that the transmission power setting is “1 (transmission power setting 1)”, it is supposed that the sensor terminals #4 and #6 do not mutually give interfere that inhibits the communication. Thus, the same time slot can be allocated to the sensor terminals #4 and #6. By allocating the same time slot to the plurality of sensor terminals 200 in this manner, it is expected that the frequency use efficiency is improved and the effects such as the reduction of network delay and the increase of the number of accommodatable sensor terminals.

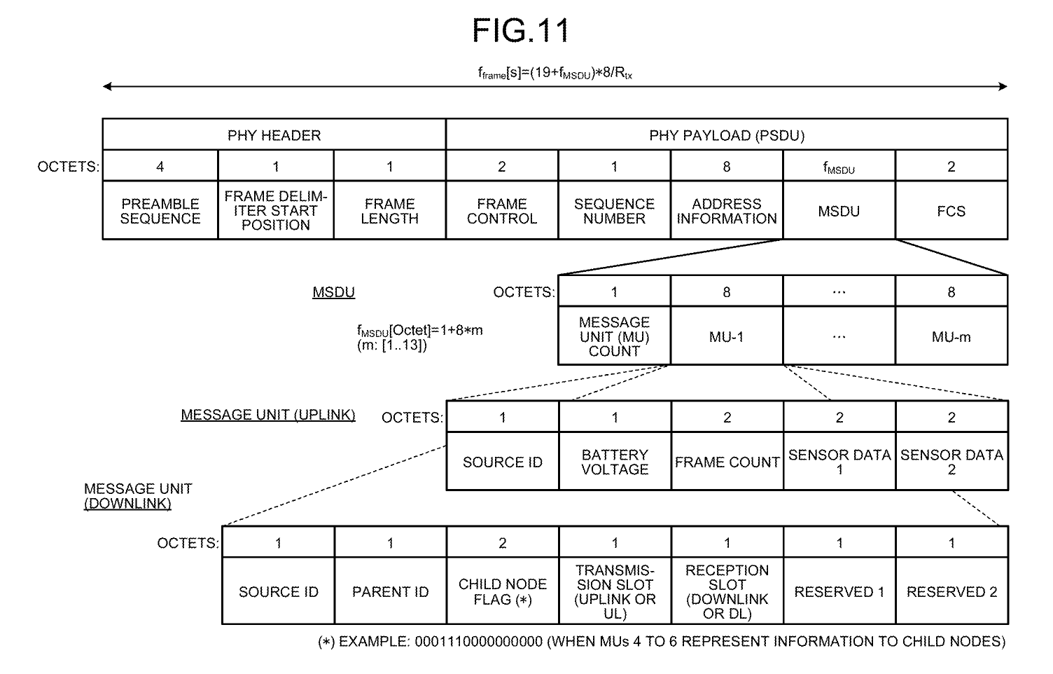

FIG. 11 is a diagram illustrating an exemplary frame format according to the embodiment. As illustrated in FIG. 11, in the uplink communication, the measurement information and the electrical power information is transmitted in 8-byte message units (MUs). During relay transmission, in addition to the MU of the concerned node, the MUs of descendent nodes are aggregated in the same frame, and all MUs are transmitted as a single frame. On the other hand, in the downlink communication, the information on the relay path is transmitted in 8-byte MUs, and the MU addressed to the concerned node is relayed while being thinned out. For that reason, from among the allocation information of the time slots, the uplink reception slots and the downlink transmission slots can be known by referring to the information in the MUs addressed to child nodes. Meanwhile, the frame format is not limited to the frame format illustrated in FIG. 11, and it is possible to use any arbitrary frame format.

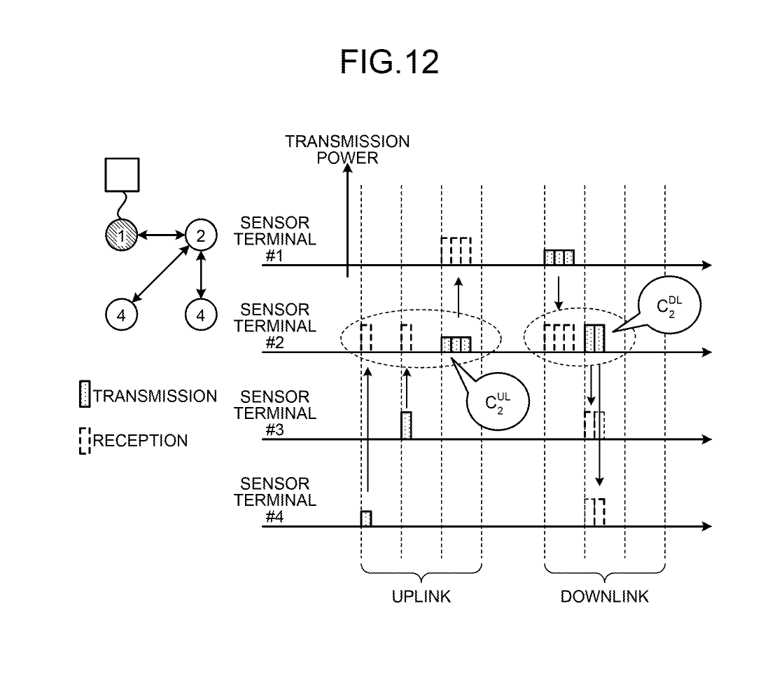

Returning to the explanation with reference to FIG. 6, the control device 100 decides on the transmission power of the sensor terminals 200 and the relay path (Step S103). Once the relay path is decided, the frame transmission count and the frame reception count of the sensor terminals 200 can be known from the communication protocol. Hence, the control device 100 decides on the relay path and the transmission power based on the transmission power settings and the relationship of connection among the sensor terminals 200 as collected at Step S101 and based on the electrical power data of the sensor terminals 200 as collected at Step S102. FIG. 12 is a diagram illustrating an example of the relay path of a super frame and the allocation of time slots.

The power consumption during transmission represents the transmission power at the transmission power setting that enables communication with the destination sensor terminal 200. At that time, power consumption C₁[J] required for the communication by a sensor terminal i can be expressed as given below in Equation (1). Herein, the sensor terminal i represents a particular sensor terminal 200, and implies the sensor terminal #i.

Cᵢ=Cᵢ^{UL}+Cᵢ^{DL}+Cᵢ^{other} (1)

In Equation (1), Cᵢ^{UL}[J] represents the power consumption during the communication in the uplink period, and Cᵢ^{DL}[J] represents the power consumption during the communication in the downlink period. Moreover, Cᵢ^{other}[J] represents the power consumption during the standby state or represents the self-discharge of the electricity generating/storing unit 210, and points to other power consumption. Of these types of power consumption, Cᵢ^{UL}[J] can be expressed as given below in Equation (2), and Cᵢ^{DL}[J] can be expressed as given below in Equation (3).

$$\begin{matrix}{C}_{i}^{UL} = {v}_{tx} ( {l}_{i , {u}_{i}}^{tx} , {n}_{i}^{desc} + 1 ) + {\sum }_{{d}_{i , j} ∈ {d}_{i}}^{ } {v}_{rx} ( {n}_{{d}_{i , j}}^{desc} + 1 ) & ( 2 ) \\ {C}_{i}^{DL} = {v}_{tx} ( {max}_{{d}_{i , j} ∈ {d}_{i}} \{ {l}_{i , {d}_{i , j}}^{tx} \} , {n}_{i}^{desc} ) + {v}_{rx} ( {n}_{{u}_{i}}^{desc} ) & ( 3 )\end{matrix}$$

Herein, vₜₓ(l^{tx}, m)[J] represents the power consumption during the communication of a single frame at transmission power setting l^{tx} (implying the transmission power setting from a sensor terminal i to a sensor terminal j at lᵢ, j^{tx}) and at a message unit count m. Moreover, vᵣₓ(m)[J] represents the electrical power required to receive a single frame having the message unit count m. Furthermore, uᵢ represents the parent node of the sensor terminal i, and di represents the set of child nodes of the sensor terminal i. Moreover, nᵢ^{desc} represents the number of descendent nodes of the sensor terminal i.

Herein, Equation (2) means that, in the uplink communication, a sensor terminal i receives frames equal in number to the number of child nodes and sends the frames once to the parent node. Moreover, Equation (3) means that, in the downlink communication, the sensor terminal i receives frames once from the parent node and sends once the frames to child nodes with the transmission power setting having the maximum transmission power from among the transmission power settings of the child nodes.

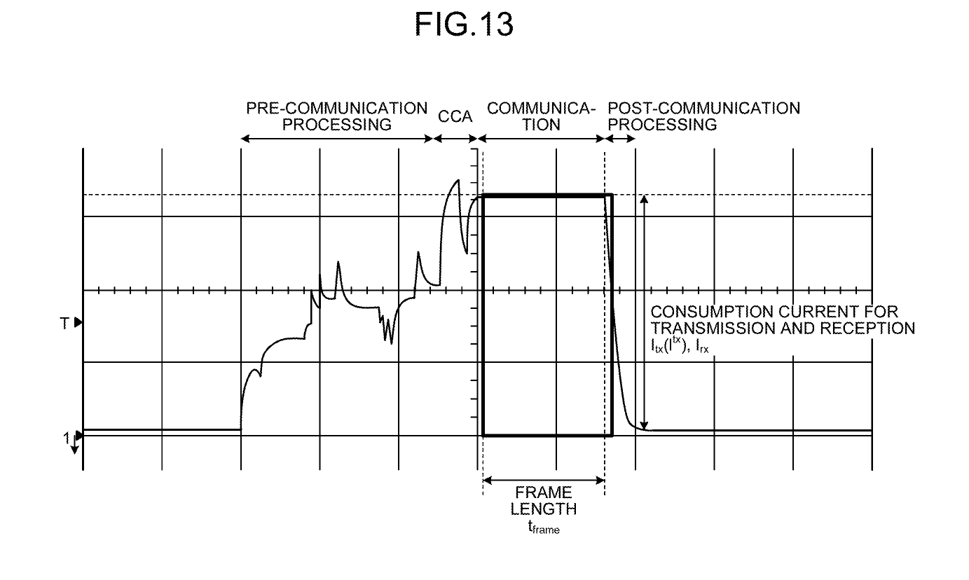

The power consumption vₜₓ(l^{tx}, m)[J] and the power consumption vᵣₓ(m)[J] can be calculated by measuring in advance the power consumption of the sensor terminals 200 that are wireless devices. FIG. 13 is a diagram illustrating an exemplary consumption current during the transmission from a particular sensor terminal 200 according to the embodiment. As illustrated in FIG. 13, the consumption current includes current during pre-communication processing (for example, clock stabilization, microcomputer processing, and wireless initialization), current during channel clear assessment (CCA), and current during post-communication processing. During the transmission, the consumption current can be expressed as given below in Equation (4) from Qₜₓ obtained by approximating the pre-communication processing and CCA; a frame duration t_{frame}(m); and a transmission consumption current Iₜₓ(l^{tx}).

vₜₓ(l^{tx},m)=t_{frame}(m)·Iₜₓ(l^{tx})+Qₜₓ (4)

During the reception, the consumption current can be expressed as given below in Equation (5) from a fixed value Qᵣₓ obtained by approximating the pre-communication processing and the post-communication processing; the frame duration t_{frame}(m); and the transmission consumption current Iₜₓ(l^{tx}).

vᵣₓ(m)=t_{frame}(m)·Iᵣₓ+Qᵣₓ (5)

These depend on the communication protocol, and the present embodiment in which each sensor terminal 200 sends the frames once in the uplink communication and sends the frames once in the downlink communication within the period of time of the super frames is as described above. Other communication protocols include, for example, a protocol according to which the sensor terminal 200 performs transmission for relay at every reception; a protocol according to which the sensor terminal 200 sends the network control information at regular intervals; and a protocol according to which the sensor terminal 200 performs retransmission when the communication fails. However, as long as the power consumption required for the communication performed by each sensor terminal 200 within the period of time of the super frames can be predicted from the relay path, any communication protocols are applicable.

Meanwhile, in the control device 100, based on the electrical power information notified by the sensor terminals 200 and measurement done in advance, the estimated surplus electricity at the starting point of the super frame k of the sensor terminal i can be calculated using Equation (6) given below.

Êᵢ[k]=Eᵢ[k−1]+Hᵢ[k−2]·T_{SF}−Cᵢ[k−1]

Êᵢ[k] represents the estimated surplus electricity (6)

In Equation (6), Eᵢ[k−1] represents the amount of stored electricity in the super frame k−1 that is notified at the last by the sensor terminal 200, and Hᵢ[k−2] represents the electric-generating capacity in the super frame k−2. Thus, the estimated surplus electricity can be calculated using the electric-generating capacity in the past or the amount of stored electricity in the past, and using the power consumption. That information can be notified from the sensor terminal 200 to the control device 100, or can be calculated using Equation (7) given below.

Hᵢ[k]=(Eᵢ[k]−Eᵢ[k−1]−Cᵢ[k−1])/T_{SF} (7)

According to the embodiment, regarding a relay path candidate RⱼεR, a relay path metric M(Rⱼ) can be expressed as given below using Equation (8).

$$M ( {R}_{j} ) = {max}_{i} \{ \frac{{C}_{i}^{{R}_{j}}}{{\hat{E}}_{i}} \}$$

Cᵢ^{R}^{ⱼ} represents the power consumption of the sensor terminal i in the relay path Rj (8)

Herein, Equation (8) indicates, in the relay path candidate, the ratio of the power consumption with respect to the surplus electricity of the sensor terminal 200 having the least electrical power margin. Meanwhile, although the metric is calculated in the sensor terminal 200 having the least electrical power margin, it is alternatively possible to calculate the metric using the average of the sensor terminals 200 or it is possible to implement some other calculation method in which an estimated value of the power consumption of the sensor terminals 200 is used. In the embodiment, the relay path can be selected/decided using Equation (9) given below.

$$R = {arg min}_{{R}_{j} ∈ R} \{ M ( {R}_{j} ) \} \qquad ( 9 )$$

Along with the relay path decided in the manner described above, the transmission power setting of each sensor terminal 200 is also decided according to the information illustrated in FIG. 9. Meanwhile, the set of relay path candidates can be searched based on the transmission power settings and the relationship of connection among the sensor terminals 200 as illustrated in FIG. 9.

Returning to the explanation with reference to FIG. 6, the control device 100 sends the decided transmission power and the decided relay path to the sensor terminals 200, so that the transmission power and the relay path are updated in each sensor terminal 200 (Step S104). Although the frame format illustrated in FIG. 11 does not include the information about the transmission power settings, it can be notified using a separate frame format. Moreover, even if the information about the transmission power setting is not notified, as long as the result of the examination performed at Step S101 is stored, the sensor terminals 200 can recognize the transmission power settings based on the information about the parent node and the child nodes. Furthermore, if the relay path in the uplink is different from the relay path in the downlink, the information about the relay paths of all sensor terminals 200 and the information about the transmission power can be notified according to the flooding in which the relay is repeated using broadcasting. The period of time only for the flooding may be set within the period of time of the super frames. In order to perform the flooding in a short time, during the period of time only for the flooding, the sensor terminals 200 may share time according to carrier sense multiple access with collision avoidance (CSMA/CA), for example.

Subsequently, the control device 100 determines whether or not the radio wave environment has changed or whether or not a predetermined period of time has elapsed (Step S105). If the radio wave environment has changed or if a predetermined period of time has elapsed (Yes at Step S105), then the control device 100 performs the operation at Step S101. On the other hand, if the radio wave environment has not changed or if a predetermined period of time has not elapsed (No at Step S105), then the control device 100 performs the operation at Step S102.

For example, in the sensor terminal 200, when the probability of failure exceeds a predetermined threshold value, it is considered as a change in the radio wave environment and a notification is sent to the parent node or to the surrounding sensor terminals 200. When a change in the radio wave environment is recognized, the control device 100 sends an examination request message. In response, the operation at Step S101 is started. Meanwhile, the method for detecting a change in the radio wave environment is not limited to the method described above. Alternatively, in the sensor terminal 200, when the communication quality deteriorates by a certain level or beyond, if the deterioration is notified as a change in the radio wave environment, then any arbitrary method can be implemented to detect a change in the radio wave environment.

Meanwhile, the relay path can be changed in a planned manner. For example, consider a case in which solar panels are used as harvesters and the sensor terminals 200 are driven using the photovoltaic power generation. In that case, regarding the outdoor electric-generating capacity in one day, it is possible to estimate that the same electric-generating capacity can be achieved if the climate is the same. Thus, the sensor terminals 200 can store hourly relay paths, and can change the relay path to be identical to the relay path history on the previous day. Such planned changes in the relay path can be performed according to instructions from the control device.

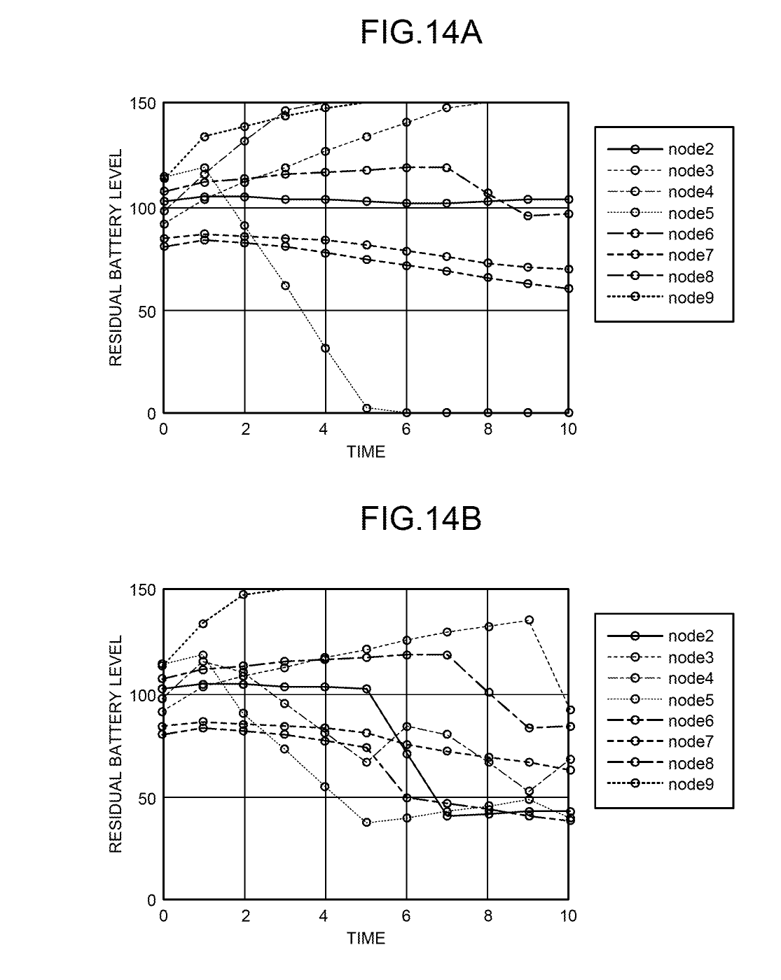

With reference to FIGS. 14A and 14B, the explanation is given about the temporal transition in the residual battery level of the sensor terminals 200 in the case when the relay path decided according to the conventional technology is used and in the case when the relay path decided according to the embodiment is used. FIG. 14A is a diagram illustrating an exemplary temporal transition in the residual battery level of the sensor terminals 200 according to the conventional technology. FIG. 14B is a diagram illustrating an exemplary temporal transition in the residual battery level of the sensor terminals 200 according to the embodiment.

In FIGS. 14A and 14B, with the node count and node positioning as illustrated in FIG. 3 and under the restriction that the maximum hop count is three and the maximum connection count is three, the conventional technology is compared with the embodiment by adding the minimum hop count in the norm as the realistic assumption. Moreover, a model is set in which the power consumption during the standby period without transmission and reception as well as the power consumption required for measurement is assumed to be constant; a random number is assigned as the initial value of the residual battery level and as the initial value of the electric-generating capacity; and the electric-generating capacity fluctuates randomly within a given range for each super frame. Furthermore, a simulation is performed in which the operation of selecting a relay path on an hourly basis; the operation of calculating the power consumption based on the relationship of connection in the decided relay path; and the operation of updating the residual battery level in accordance with the electric-generating capacity are repeated.

In the example illustrated in FIG. 14A, node5 (the sensor terminal 200 positioned in the center in FIG. 7) has a large power consumption, and the residual battery level becomes “0” at a particular timing. In the conventional technology, such a situation occurs because mediation with the other sensor terminals 200 is not performed and there is no option of increasing the transmission power and performing a relay using a farther sensor terminal 200 while sacrificing the power consumption, and hence a situation in which the load gets concentrated on only some of the sensor terminals 200 cannot be avoided. In contrast, in the example illustrated in FIG. 14B, although there is an increase in the power consumption of node5 in the early stages, the load of the communication changes to node2 from a particular timing. As a result, it can be confirmed that the residual battery level of node5 also recovers.

As described above, in the control system 10, the candidate relay paths include connection with such sensor terminals 200 which are connectible in response to an increase in the transmission power; and the selection/decision of the relay path is done based on the power consumption, the residual battery level, and the electric-generating capacity of individual sensor terminals 200 by taking into account the entire relay path. As a result, in the control system 10, since the communication load does not get concentrated on only some of the sensor terminals 200, the sensor network can be operated with stability.

Meanwhile, in the case of changing the relay path in a planned manner on the basis of estimation of the electric-generating capacity, it becomes possible to skip the examination of the relationship of connection with respect to the transmission power settings among the sensor terminals 200 and to skip the examination result report. As a result, it becomes possible to hold down the power consumption of the sensor terminals 200 in the control system 10. In the control system 10, since it becomes possible to hold down the power consumption of the sensor terminals 200, the sensor network can be operated with stability.

The processing procedures, the control procedures, specific names, various data, and information including parameters described in the embodiment or illustrated in the drawings can be changed as required unless otherwise specified. The constituent elements of the device illustrated in the drawings are merely conceptual, and need not be physically configured as illustrated. The constituent elements, as a whole or in part, can be separated or integrated either functionally or physically based on various types of loads or use conditions.

The control device 100 and the sensor terminals 200 can be implemented using, for example, a general-purpose computer device as the basic hardware. Moreover, the computer programs that are executed contain modules of the functions described above. The computer programs can be recorded as installable or executable files in a computer-readable recording medium such as a compact disk read only memory (CD-ROM), a compact disk recordable (CD-R), or a digital video disk (DVD); or alternatively can be stored in advance in a read only memory (ROM).

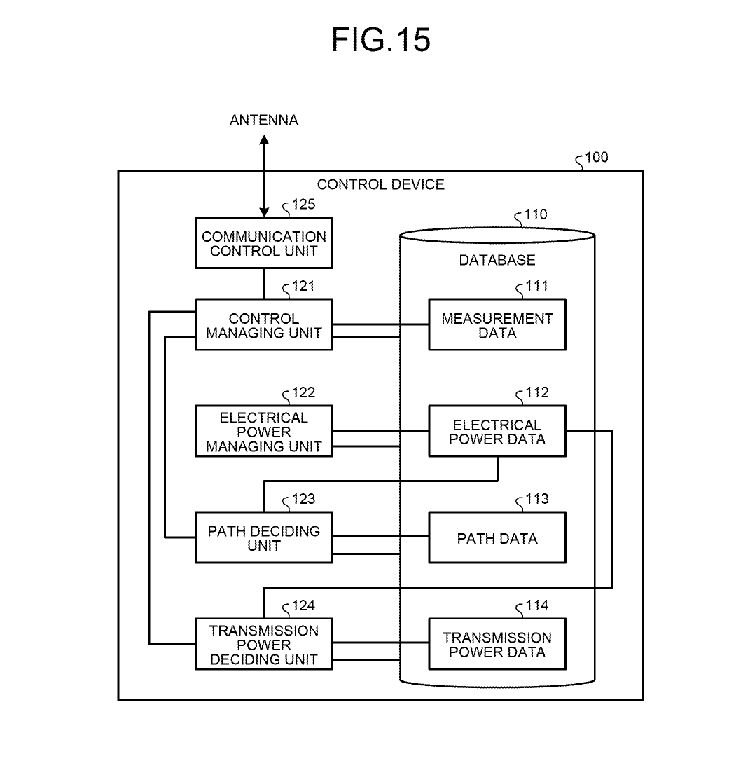

FIG. 15 is a block diagram illustrating another functional configuration of the control device 100 according to the embodiment. For example, as illustrated in FIG. 15, the control device 100 may further include a communication control unit 125 having a wireless communication function in addition to the functional configuration of the above-described embodiment. According to such configuration, operation can be done in the control system 10 without using a wired connection to the sensor terminals 200 or without embedding the communication control unit in the sensor terminal 200.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A control device that is connected to a network including sensor terminals having wireless communication function, the control device comprising:
a collecting unit configured to collect, from the sensor terminals, electrical power data containing, from among amount of stored electricity and electric-generating capacity of the sensor terminal, at least the amount of stored electricity and containing relationship information of a communicable sensor terminal;
a calculating unit configured to generate, based on the relationship information, a plurality of relay path candidates for communication data and calculate, for the relay path candidates, power consumption of the sensor terminal;
a deciding unit configured to decide on a relay path for communication among the sensor terminals based on the calculated power consumption and the collected electrical power data; and
a communication control unit configured to notify the sensor terminal about information of the decided relay path.

2. The device according to claim 1, wherein the calculating unit calculates the power consumption to be greater regarding the sensor terminal which has a greater number of other sensor terminals for relaying the communication data.

3. The device according to claim 1, wherein
the calculating unit calculates surplus electricity of the sensor terminal from the electrical power data, and
the deciding unit decides on the relay path from among the candidates for relay path based on ratio of the surplus electricity with respect to the power consumption for the sensor terminals.

4. The device according to claim 3, wherein the calculating unit calculates the surplus electricity from the amount of stored electricity in past or the electric-generating capacity in past and from the power consumption.

5. The device according to claim 1, wherein
the collecting unit collects setting information of variable transmission power used in communication among the sensor terminals, and
the deciding unit decides on the relay path and transmission power of the sensor terminal from the collected setting information of the transmission power data and from the electrical power data.

6. A sensor terminal having wireless communication function comprising:
a detecting unit configured to detect, from amount of stored electricity in an electricity storing unit and electric-generating capacity of an electric-generating unit, at least the amount of stored electricity;
a communication control unit configured to perform control to send electrical power data containing, from among the amount of stored electricity and the electric-generating capacity, at least the amount of stored electricity to a control device connected to a network including the sensor terminal; and
a setting changing unit configured to change setting of a relay path for communication among sensor terminals and change setting of transmission power of the wireless communication function, according to a notification from the control device.

7. The terminal according to claim 6, wherein, when a calculated value based on the electrical power data is equal to or greater than a predetermined threshold value, the communication control unit performs control to send the electrical power data and the relationship information to the control device.

8. A control system comprising:
one or more sensor terminals having wireless communication function; and
a control device connected to a network including the sensor terminals, wherein
the control device includes
a collecting unit configured to collect, from the sensor terminals, electrical power data containing, from among amount of stored electricity and electric-generating capacity of the sensor terminal, at least the amount of stored electricity and containing relationship information of a communicable sensor terminal;
a calculating unit configured to generate, based on the relationship information, a plurality of relay path candidates for communication data and calculate, for the relay path candidates, power consumption of the sensor terminal;
a deciding unit configured to decide on a relay path for communication among the sensor terminals based on the calculated power consumption and the collected electrical power data; and
a communication control unit configured to notify the sensor terminal about information of the decided relay path,
the sensor terminals include
a detecting unit configured to detect, from amount of stored electricity in an electricity storing unit and electric-generating capacity of an electric-generating unit, at least the amount of stored electricity;
a communication control unit configured to perform control to send electrical power data containing, from among the amount of stored electricity and the electric-generating capacity, at least the amount of stored electricity to a control device connected to a network including the sensor terminal; and
a setting changing unit configured to change setting of a relay path for communication among sensor terminals and change setting of transmission power of the wireless communication function, according to a notification from the control device.
